(19) United States
(12) Patent Application Publication
(10) Pub. No.: US 2017/0046978 A1
(43) Pub. Date: Feb. 16, 2017

(54) Conjoined, pre-programmed, and user controlled virtual extremities to simulate physical re-training movements

(71) Applicant: Vincent J. Macri, Tallahassee, FL (US)

(72) Inventor: Vincent J. Macri, Tallahassee, FL (US)

(21) Appl. No.: 15/330,133

(22) Filed: Aug. 13, 2016

Related U.S. Application Data
(60) Provisional application No. 62/282,864, filed on Aug. 14, 2015.

(51) Int. Cl. G09B 19/00; G09B 5/00; A63F 13/213; A63F 13/2145; A63F 13/212; A63B 71/06; A63F 13/285

(52) U.S. Cl. CPC G09B 19/003; A63B 71/0622; G09B 5/00; A63F 13/285; A63F 13/2145; A63F 13/212; A63F 13/213; A63B 2071/0647; A63F 2300/8082

(57) ABSTRACT

The present invention is in the technical field of virtual reality therapy/rehabilitation (VRT/R) for survivors of acquired brain injury (ABI) and other brain-affected individuals who experience disrupted brain-to-extremities communications to intact, existing and anatomically original, but disabled extremities. Specifically the present invention is directed to assisting survivors of acquired brain injury (ABI) traumatic brain injury, autism spectrum disorder, focal dystonias and other brain-affected individuals by computer-presenting/displaying a combination of virtual anatomical extremities (VAEs) in two forms: 1-VAEs which are computer pre-programmed to make simulated physical movements according to the programmer's design and purpose; and 2-VAEs which are interactively and tactically controlled/directed by users to make custom-purposed simulated physical movements according to the user's design and purpose. This invention conjoins the use of 1-VAEs and 2-VAEs to provide ABI survivors and other brain-to body-affected individuals with realistic, anatomically analogous controls over one or more virtual disabled extremities and one or more virtual unaffected extremities.

### BACKGROUND OF THE INVENTION

Survivors of acquired brain injury (ABI) and other brain-to body-affected individuals (collectively, users) often experience disruptions in brain-to-extremities communications to control disabled extremities which are intact, existing and anatomically original. Users' therapy is hampered by the challenge to restore movement and control of disabled extremities before the extremities are capable of movement. In many cases the primary site of injury is the brain, but few physical and occupational therapies are specifically directed to exercises to stimulate the brain in order to restore brain-to-disabled-extremities communications. This invention combines input control of digital, virtual, anatomical extremities (VAEs) presented on computers to users in two forms: first form VAEs (1-VAEs) images which are computer pre-programmed to present simulated physical movements and second form VAEs (2-VAEs) images which are interactively user-controlled and directed to make purposeful simulated physical movements. For example, to remove a virtual lid from a virtual jar a user with a disabled left hand would use a third person input to a 1-VAE virtual right hand to grasp the jar and third person inputs to a 2-VAE to control twisting a virtual, disabled left hand to remove the virtual lid from the virtual jar. Said 2-VAEs are constructed by storing user anatomical and physiological data in a database; and creating user-controllable/directed 2-VAE images based on a body model derived from said users' anatomical and physiological data;

### SUMMARY OF THE INVENTION

The present invention is in the technical field of virtual reality therapy/rehabilitation (VRT/R) for survivors of acquired brain injury (ABI) and other brain-affected individuals (collectively, users) who experience disrupted brain-to-extremities communications to intact, existing and anatomically original, but disabled extremities.

Specifically the present invention is directed to assisting survivors of acquired brain injury (ABI) traumatic brain injury, autism spectrum disorder, focal dystonias and other brain-affected individuals by computer-presenting/displaying to users a combination of virtual anatomical extremities and other body parts (virtual images) in two forms: 1-VAEs which are computer pre-programmed to make simulated physical movements according to the programmer's design and purpose; and 2-VAEs which are interactively and tactically controlled/directed by users to make custom-user-purposed simulated physical movements.

The present invention conjoins two forms of VRT/R, i.e. 1-VAEs in which inputs go to computer pre-programmed, icons, avatars, and/or virtual images which may include virtual anatomical extremities and other body parts and which may be third-person caused to make simulated, physical movements and 2-VAEs for which third person user inputs control and direct 2-VAEs to simulate physical movements i.e. the user's present tense anatomical movement controls/directions and tactics which are initiated by user kinetic imagery and instantiated by controlling/directing virtual anatomical extremities. The use of 1-VAEs is to cause a simulated movement goal to be reached, but the particular way (how) it is reached is pre-programmed so that the user's third person action is simply to choose the pre-programmed movement not to control and direct it. That is to say, how the movement goal is reached follows the programmer's purpose and design, not the user's. The end of 2-VAEs is to re-train/restore brain-to-extremities-communications (synonymously, commands) to disabled physical extremities in order to achieve functional utility. In 2-VAEs each user controls at least one virtual extremity counterpart to the user's at least one disabled physical extremity to simulate the kinds of physical movements/functions previously made by the user. In 2-VAEs the particular way in which, (the how) said virtual movements are made are by users' third person inputs and idiosyncratic custom-control which follow the user's purpose.

### DETAILED DESCRIPTION OF THE INVENTION

The present invention discloses users' rehabilitation/therapy which includes use of pre-programmed images, i.e. 1-VAEs (including for example and without limitation, icons, avatars and/or images) which represent virtual extremities, body parts and objects. Said pre-programmed images are user-activated so that displayed simulated physical movements reflect users' goals, but the anatomical tactics for the way, i.e. the how to make said movements have been decided (past tense) and pre-programmed by game designers and/or programmers. Disabled users' brain processes in the 1-VAE form of VRT/R are therefore directed, mostly by command inputs, not control by third person inputs as in 2VAE which result in purposed, simulated physical movements and represent the user's present tense, interactive anatomical movement controls/directions and tactics, which are initiated by user kinetic imagery and instantiated by controlling virtual anatomical extremities in order to make simulated physical, purposed movements each disabled survivor would make absent the particular disability.

The new and useful art of the present invention is in conjoining 1-VAEs and 2-VAEs, in order to simulate physical movements when at least two extremities (body parts) are involved. For example when one extremity grasps (1-VAE) and another extremity (2-VAE) twists, hammers, or key punches as in holding a mobile phone with one hand and tapping numbers of a phone number with another hand. Thus, conjoined new art makes it possible for therapy/rehabilitation to include pre-programmed images, avatars, icons and the like with user-controlled virtual extremities which are anatomically realistic and have true range of motion. The latter 2-VUEs are used as interactive virtual extremities and are coded to respond and move strictly to each user's third person inputs. Users of 2-VAEs control/direct virtual extremities so as to make tactical, particular, selected, sequenced anatomical movements which are custom-purposed (idiosyncratically) by each user to simulate physical movements best suited to rehabilitate the user's specific disability.

This invention conjoins the use of 1-VAEs and 2-VAEs. The purpose is to provide ABI survivors and other brain-to body-affected individuals with realistic, anatomically analogous controls over one or more virtual disabled extremities and one or more virtual unaffected extremities. In 2-VAEs, the user controls one or more virtual unaffected extremities, in any timeframe, to accomplish activities of daily living. For example, to twist the lid off a jar a user with a disabled left hand and unaffected right hand would grasp the virtual jar using the pre-programmed movement of a 1-VAEs, (virtual unaffected right hand) and twist the lid by controlling a 2-VAEs virtual disabled left hand. The conjoined process most closely tracks and mimics what the ABI survivor could do pre-brain injury or condition and most directly re-trains for re-gaining/restoring brain-motor control and command of the disabled left hand.

For example, ABI survivors have a major, pervasive problem, i.e. how to re-learn to control disabled physical extremities before/without being able to move them. ABI, such as stroke and/or traumatic brain injury leaves survivors with disabled extremities which may include one or more intact, existing and original, but uncontrollable, disabled legs, feet, arms, hands and/or fingers. Since survivors cannot physically move disabled limbs 2-VAEs provides interactive virtual extremities, in effect a neuroprosthetic platform of exercises and games which makes it possible to exercise brain process most specific to motor (physical) movements. The brain, as the command and control organ of the human body, acquires communications links to the body exceedingly specifically: for example, learning to play any of Mozart's 27 piano concertos does nothing to execute one's tennis backhand or golf putting accuracy.

Conjoining pre-programmed and user controlled virtual extremities to simulate purposeful physical re-training movements is supported by at least the following:
learning/training to make purposeful physical movements requires personal, brain-to-extremities (including core body) processes;
no one can physically train for you;
movement is idiosyncratic notwithstanding the goals of movements being universal (e.g. walking is universal, each person's walk is distinctive);
if one is ABI or otherwise brain-to body-affected-disabled, physical movements are brain-to-disabled extremity(ies) “off-line”, the damaged brain no longer communicates as it did to the extremities pre-injury;
users must re-train (by definition, idiosyncratically to move i.e. to control extremities);
no one can virtually, physically re-train for you;
disabled individuals can be assisted, receive therapy and engage in rehabilitation, i.e. to re-train to move extremities they cannot move;
the most effective re-training is to move track/mimic original training to move, i.e. particular brain-to-extremities processes;
particular brain-to-extremities physical movement processes are neither invoked by playing Sudoku or Angry Birds games, nor by clicking on avatars which are pre-programmed to move according to someone else's purpose, i.e. the game programmer's purpose;
in effect, pre-programming a movement goal of a virtual extremity is not controlling a virtual extremity for one's own re-training/rehabilitation purpose, it is [video] game building. Controlling avatars' pre-programmed movements trains one's brain for the game, not to re-gain control over one's extremities;
ABI survivors (synonymously users) who cannot move extremities and choose to use VR retraining should control 2-VAEs virtual as closest to a physical/occupational brain-to-disabled-extremity rehabilitation process;
combining 1VAE and 2-VAEs will improve rehabilitation/therapy protocols.

The method for improving performance of physical actions of a user with an affected brain comprises the steps of providing to the user on an apparatus one or more self-teaching virtual training games that simulate at least one physical action using a user-controllable image and a pre-programmed image; constructing the user-controllable image configured to the user by: storing anatomical and physiological data in a database; and creating the user-controllable image based on a body model derived from said anatomical and physiological data; displaying on a display device the constructed user-controllable image; receiving, from an input device controlled by the user, inputs that control the simulated physical action of the user-controllable image generated by the apparatus; displaying on a display device the pre-programmed image; receiving, from an input device controlled by the user, inputs that control the simulated physical action of the pre-programmed image generated by the apparatus; providing feedback to the user based on the simulated physical action via a mechanical feedback device that may attach to at least one body part of the user; wherein the user inputs controlling the user-controllable image instantiate the kinetic imagery of the simulated physical action of the user; and wherein the instantiation of kinetic imagery of the simulated physical action and feedback to the user based on the simulated physical action of the user-controllable image and pre-programmed image are associated with improving performance of the physical action of the user. Additionally, the method comprises the feedback device receiving one or more feedback control messages from a computer device. Additionally, the method comprises the input device being a computer mouse, a touch-screen, a device configured to measure user head movements, a device configured to measure user eye movements, a brain-computer interface, or a wired communications device or wireless communications device. Additionally, the method comprises the user-controllable image comprises virtual body parts exhibiting analogous true range of motion to simulate physical movements. Additionally, the method comprises the user-controllable image allows the user to control and direct a virtual body part to display virtual true full range of motion to simulate physical movements.

What is claimed is:

1. A method for improving performance of physical actions of a user with an affected brain comprising:
providing to the user on an apparatus one or more self-teaching virtual training games that simulate at least one physical action using a user-controllable image and a pre-programmed image;
constructing the user-controllable image configured to the user by: storing anatomical and physiological data in a database; and creating the user-controllable image based on a body model derived from said anatomical and physiological data;
displaying on a display device the constructed user-controllable image;
receiving, from an input device controlled by the user, inputs that control the simulated physical action of the user-controllable image generated by the apparatus;
displaying on a display device the pre-programmed image;
receiving, from an input device controlled by the user, inputs that control the simulated physical action of the pre-programmed image generated by the apparatus;
providing feedback to the user based on the simulated physical action via a mechanical feedback device that may attach to at least one body part of the user;
wherein the user inputs controlling the user-controllable image instantiate the kinetic imagery of the simulated physical action of the user; and
wherein the instantiation of kinetic imagery of the simulated physical action and feedback to the user based on the simulated physical action of the user-controllable image and pre-programmed image are associated with improving performance of the physical action of the user.

2. The method of claim 1, wherein the feedback device receives one or more feedback control messages from a computer device.

3. The method of claim 1 wherein the input device is a computer mouse, a touch-screen, a device configured to measure user head movements, a device configured to measure user eye movements, a brain-computer interface, or a wired communications device or wireless communications device.

4. The method of claim 1, wherein the user-controllable image comprises virtual body parts exhibiting analogous true range of motion to simulate physical movements.

5. The method of claim 1, wherein the user-controllable image allows the user to control and direct a virtual body part to display virtual true full range of motion to simulate physical movements.
